(19) United States
(12) Patent Application Publication
(10) Pub. No.: US 2004/0043797 A1
(43) Pub. Date: Mar. 4, 2004

(54) Method and apparatus for power conservation in a wireless communication system

(76) Inventor: Robert E. Shostak, Portola Valley, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/232,079

(22) Filed: Aug. 30, 2002

(51) Int. Cl. H04B 1/38

(52) U.S. Cl. 455/574; 455/517

(57) ABSTRACT

A method and apparatus for reducing the amount of power that is required when using a wireless communication protocol, such as IEEE 802.11, is presented. In a wireless communication system, a mobile device that is a part of the communication system must be “awake” in order to send or receive a message. A device in an “awake” mode consumes more power than a device in its “asleep” mode. The invention obviates the need for a device to wake up frequently to receive gateway broadcasts. Instead of waking up for every broadcast, the device remains awake for a predetermined “holdover period” after sending a message. By reducing the total amount of time the device is “awake,” the invention achieves significant power savings. The holdover period should be set so that it is short enough to achieve the desired amount of power savings without slowing down the speed of communication too much.

### BACKGROUND

Voice-controlled wireless communication system protocols, such as IEEE 802.11, are becoming increasingly widely used. As these protocols were designed to be used primarily by devices such as laptop computers, power conservation is generally not a main design concern for chip sets that support such protocols. Unfortunately, the high power consumption associated with these communication protocols make these protocols difficult to use with smaller, battery-powered communication devices that are entering the consumer market.

As small, battery-powered communication devices become more ubiquitous, measures are taken to reduce the level of power consumption by these wireless communication protocols. For example, the IEEE 802.11b standard provides for a relatively low-powered mode of operation called Power Save Polling (PSP). A device operating in the PSP mode spends most of its time in a low-power “sleep” mode in which both the radio transmitter and receiver are inactive. Periodically, the receiver awakens to listen for a beacon signal transmitted by the access point with which it is currently associated. The interval at which the receiver awakens is commonly referred to as the “listening interval.”

An access point sends beacon signals to the associated devices at a regular interval. This interval is referred to as the “beacon interval.” If the beacon interval is 100 ms, a device associated with the access point can receive a beacon signal as frequently as every 100 ms (i.e., every signal is received as soon as it arrives). The beacon signal indicates whether the access point has buffered data to be delivered to the device. If a device receives a beacon signal indicating that there is buffered data, the device requests delivery of the data. If there is no such signal, the device returns to the “sleep” mode for another listening interval.

The beacon interval being 100 ms does not mean a device has to receive the beacon signal every 100 ms, because the listening interval does not have to be the same as the beacon interval. The listening interval can be set for a device as a multiple of the beacon interval. So, for example, a device may have a listening interval of 500 ms rather than 100 ms. If the beacon interval is 100 ms and the listening interval is 500 ms, the device will be receiving one of every five beacon signals. Therefore, there is some latency in data receipt compared to the situation where the listening interval is the same as the beacon interval. However, setting the listening interval to be longer than the beacon interval allows a device to operate at a lower level of power consumption because power is consumed every time the device switches from a “sleep” mode to an awakened mode to receive a signal.

The amount of power savings achieved as a result of using PSP is not as drastic as one might expect, for two reasons. One reason is that during the time between the beacon signals, (i.e., when the radio receiver is “asleep”), the radio receiver actually cannot be turned off completely. Thus, even in its “sleep” mode, the radio receiver is drawing power. In an exemplary case, the receiver draws approximately 60 milliamps in the “sleep” mode and 200 milliamps when awake.

Another reason PSP does not result in as much a power savings as expected is related to the receipt of broadcast packets. Generally, local area networks (LANs) have a physical medium in which all devices on the LAN are interconnected. A protocol corresponding to this physical medium is referred to as a “broadcast” protocol, wherein a packet is sent to every device that is a part of the LAN. Each packet that is broadcast typically contains information allowing each device on the LAN to recognize whether the packet is intended for that device. Ethernet and token ring are two examples of widely used broadcast protocols.

The radio receiver in a wireless communication device needs to wake up not only to receive beacon signals but also to receive broadcast packets. The interval for the signals carrying Delivery Traffic Indication Message (DTIM) information, which indicates that the information is part of the broadcast traffic, is typically a small multiple of the beacon interval. For example, where the beacon interval is 100 ms, DTIM interval may be 200 ms. Thus, if a device is part of a system that sends out broadcast packets, the device may need to wake up much more frequently (e.g., every 200 ms) than suggested by the listening interval (e.g., 500 ms). A device's waking up every 200 ms does not result in significant power savings over a device's waking up every 100 ms. In fact, it is desirable that the radio receiver only wake up every 500 ms if there is to be a significant power savings without too long a latency in receiving and responding to incoming messages.

In a system that sends out broadcast packets, a device needs to wake up for all signals that carry DTIM information. The DTIM interval may be set on the access point. The need to listen for broadcast traffic is a fundamental aspect of the Internet Protocol suite. Thus, a device that is to be reachable by other devices on the network must listen for and respond to Address Resolution Protocol (ARP) requests that are broadcast by other devices. Responding to ARP requests allows IP addresses of the devices to be resolved to a physical (MAC) address.

A method and system for using the IEEE 802.11b communication protocol with lower power consumption is needed.

### SUMMARY OF THE INVENTION

A method of reducing the amount of power that is required when using a wireless communication protocol, such as IEEE 802.11, is presented. A device that communicates with a central computer (a server) periodically sends a message to the central computer and receives a response to the message from the central computer. Sometimes, the response arrives almost immediately after the device sends off a message to the central computer. At other times, however, the response arrives a little later depending on how the response was routed in the communication network. Since the device has to be “awake” to send or receive messages, the message's arriving a little later sometimes results in the message's arriving after the device has gone back to its “asleep” state where it is unable to receive the message. In this case, the message cannot be received until the next time the device wakes up. Thus, there is a latency between the time the central computer sends a response and the time when the device receives the response. This latency can be minimized if the device is programmed to wake up very frequently, for example at every broadcast interval. However, there is the problem of high power consumption associated with a device's waking up frequently because power consumption in the “awake” state is much higher than the power consumption in the “asleep” state.

The current system requires a device in the communication network to wake up for every broadcast message, thereby consuming a lot of power. The invention achieves power conservation by obviating the need for the device to wake up for every broadcast. Specifically, the invention includes programming the device to remain awake for a predetermined “holdover period” after sending a message. The holdover period should be long enough to receive responses that arrive at the device via an indirect route but short enough that a significant power savings is achieved. In addition, the device may be programmed to wake up intermittently within a holdover period (e.g., at listening intervals) as long as it does not significantly decrease the level of power savings.

### BRIEF DESCRIPTION OF THE DRAWINGS

FIG. 1 illustrates an example of a preferred embodiment of the voice-controlled wireless communication system in accordance with the invention;

FIG. 2 is a block diagram of an exemplary access point in accordance with the invention;

FIG. 3 is a block diagram of an exemplary server in accordance with the invention;

FIG. 4 illustrates more details of the server shown in FIG. 3;

FIGS. 5A-5H illustrate a first embodiment of the badge in accordance with the invention;

FIG. 5I is a block diagram illustrating the hardware components of the badge in accordance with the invention;

FIG. 6 illustrates an exemplary network of LANs in which the invention can be implemented;

FIG. 7 illustrates a ping packet sent to a central computer within the same LAN as the ping originating device;

FIG. 8 illustrates a ping response packet sent to the ping originating device of FIG. 7;

FIG. 9 illustrates a ping packet sent to a central computer in a different LAN as the ping originating device;

FIG. 10 illustrates a ping response packet sent to the ping originating device of FIG. 9 by the same route the ping packet of FIG. 9 took to reach the central computer;

FIG. 11 illustrates a ping response packet sent to the ping originating device of FIG. 9 by a different route than the route ping packet took to reach the central computer; and

FIG. 12 illustrates the Power Save Polling patterns of devices that are configured in three different ways.

### DETAILED DESCRIPTION OF THE PREFERRED EMBODIMENT

The invention is particularly applicable to a voice-controlled wireless communication system that uses Bluetooth or IEEE 802.11 as a communications protocol and an Ethernet communications/computer network, and it is in this context that the invention will be described. It will be appreciated, however, that the method of power conservation in accordance with the invention has greater utility since it can be implemented using various different communication protocols and various different computer networks.

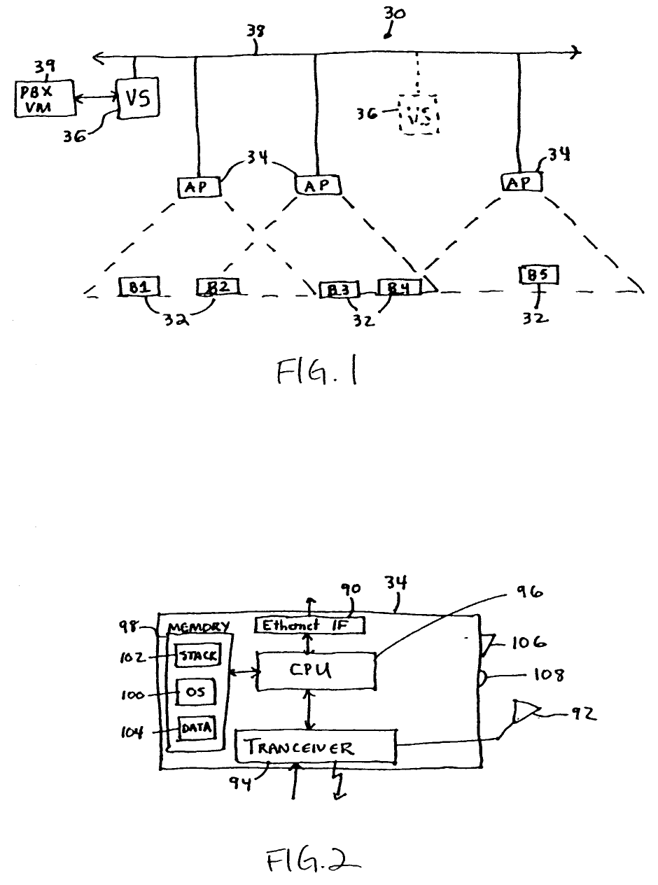

FIG. 1 illustrates an example of a preferred embodiment of the voice-controlled wireless communications system 30 in accordance with the invention. In particular, the system comprises a plurality of wireless user devices (B1-B6 in this example) 32, one or more wireless access points (AP) 34 and one or more central computers (VS) 36, such as a server computer, as shown. The wireless communications system 30 permits communication between devices in the same building wherein the access points 34 and the server 36 are connected to each other and communicate with each other over a local area network (LAN) 38. The voice-controlled wireless communications system 30, however, is not limited to being implemented using a LAN since it may also be implemented any other type of communication/computer network. For example, for a large company with multiple buildings, a company wide voice-controlled wireless communications system may be provided wherein the building may be interconnected using a wide area network (WAN), there may be a central computer 36 located at each building which communicates with other central computers over the WAN, and each building may have a LAN with a central computer 36, one or more access points 34 and a plurality of devices 32. In a preferred embodiment, the computer network may be an Ethernet based network, the central computer 36 may be a typical server computer with additional features described below, each access point 34 may be a wireless access point that uses a particular wireless protocol, such as Bluetooth or the IEEE 802.11 standard and the wireless devices 32 are capable of communicating with the access points using the particular protocol. Thus, if the access points are implemented using the Bluetooth protocol, then the devices will have Bluetooth transceivers or if the access points are implemented using the IEEE 802.11 standard, then the devices will have 802.11 compliant transceivers.

The voice-controlled wireless communications system shown has a primary central computer 36 and a backup central computer (shown in phantom) that are both connected to the computer network 38. Each central computer 36 may also be connected to a telephone system 39, such as the public branch exchange system (PBX) and voicemail (VM) system shown, that permits the server to set up, manage and take down communications sessions between a user of the system that has a device and a third party. Each access point 34 is also connected to the computer network 38 and communicates with the central computers 36 over the computer network. The access points 34 each have a limited range of operation/coverage 40, known as a network neighborhood, as shown. To permit handoff between access points as a person with a device moves between different network neighborhoods, the network neighborhoods may preferably overlap to permit handoff without dropping a communications session. The access points may communicate with each device 32 using a wireless protocol, such as Bluetooth or the IEEE 802.11 standard. In general, each access point is capable of handling some predetermined number of active devices (e.g., devices that are actively communicating with the central computer or actively engaged in a call with someone) so that more than one device may be needed in a particular high density area with multiple devices. Each device 32 may be a computerized device, such as a laptop. The device 32 may also be a small, lightweight, voice-controlled, wireless device that is capable of communicating with an access point, such as the device described in U.S. patent application Ser. No. 09/947,235, which is herein incorporated by reference in its entirety. Each device is preferably powered by a rechargeable battery. In general, each device is an access device to the voice-controlled wireless communications system, but does not perform much of the actual processing since the processing power of each device is relatively small. Thus, each device will communicate with the central computer 36 through an adjacent access point in order to implement the desired wireless communication functions that are described in more detail below.

In operation, a user that wants to initiate a wireless communications function may first register with central computer 36 and activate his/her device in some manner. The activation causes an adjacent access point (where the device is within the network neighborhood of the access point) to establish a communications session with the particular device. The user is notified that activation is complete and then speaks his command which is received by the device using its microphone and converted into digital data. The device 32 may then communicate the digital command data to the access point which in turn sends the digital command data to the central computer 36 over the computer network. The server may then analyze the digital command data in order to determine the command issued by the user, such as “Where is Paul Barsely”. If the central computer is able to properly identify the command, then it will execute the appropriate instructions to perform the commanded operation. If the central computer cannot properly interpret the command, it may request the user to try the command again. In this manner, the user is able, using only his voice, to perform various wireless communication functions wherein the central computer implements most of the functions.

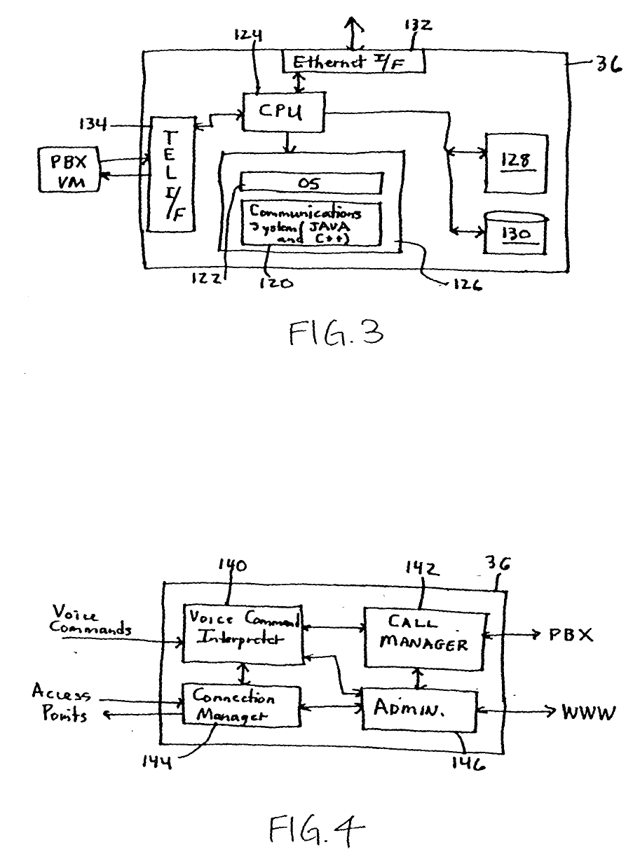

FIG. 2 is a block diagram of an exemplary access point 34 in accordance with the invention. As described above, the wireless system 30 may include at least one and typically several access point units situated at various locations within the customer premises so that the network neighborhoods of the access points preferably overlap. Each access point 34 is connected to the computer network 38 (see FIG. 1) by a computer network interface 90. Depending on the installation, the access point may be plugged into as standard RJ45 Ethernet jack (intended typically for workstation nodes) using the Ethernet interface as shown in FIG. 2 and it may be mounted on the wall. Alternatively, the access point may be located within the area above a drop-down tiled ceiling. The power for the access point may be provided by the network cable itself (according to a new standard) or the access point may be connected to an AC source.

Each access point may include an external antennae 92 which may be supplied in several different variations, depending on the requirements of the particular installation. For example, the antenna may have directional gain and may be mounted outside the building and connected to the access point via a feed-through through a window for an outside access point. Alternatively, the antennae may be mounted adjacent to the access point inside of a building area.

In principle, each access point serves a predetermined radius. The actual radius depends on the type of wireless technology being used. For example, for a Bluetooth wireless technology, a radius of approximately 35 meters of coverage indoors and 100 meters out-of-doors may be typical. Each such area of coverage is said to be a cell. As described above, access point spacing must be such that there is sufficient cell overlap that hand-off of devices from one access point to the next can be accommodated. The spacing of access points is also a function of the anticipated conversation density. In particular, each access point is typically able to manage up to seven active devices (i.e., seven concurrent active connections). In situations where a greater number of active connections are likely within a given area, cell size can be reduced (and the number of access points increased).

Each access point further comprises a wireless transceiver 94 connected to the antennae that communicates with the devices. In one embodiment, the transceiver may be a Bluetooth transceiver while in a preferred embodiment, the transceiver may be a radio transceiver that implements the IEEE 802.11 standard. The access point may further include a central processing unit (CPU) 96 that control the transceiver and the computer network interface 90. In a preferred embodiment, the CPU may be a 32-bit RISC processor. The access point may further include memory 98 (which may include both memory chip devices as well as persistent storage devices) that stores the instructions and software used by the CPU 96 to control the operation of the access point. For example, the memory may include an operating system 100, an Ethernet-based TCP/IP stack 102 and data 104 associated with the operation of the access point. For example, the access point may temporarily buffer the voice data from a device prior to communicating it to the central computer over the computer network. The access point may also include a control switch 106, such as an on/off switch and a status indicator 108, such as a pilot LED.

As is well known, each access point is factory-assigned a unique network medium access control (MAC) address and can be assigned an IP address either through a dynamic host configuration protocol (DHCP) or through wireless programming using special wireless communication system installation tools (e.g., possibly a device with special firmware). Now, the central computer (a server in the preferred embodiment) will be described in more detail.

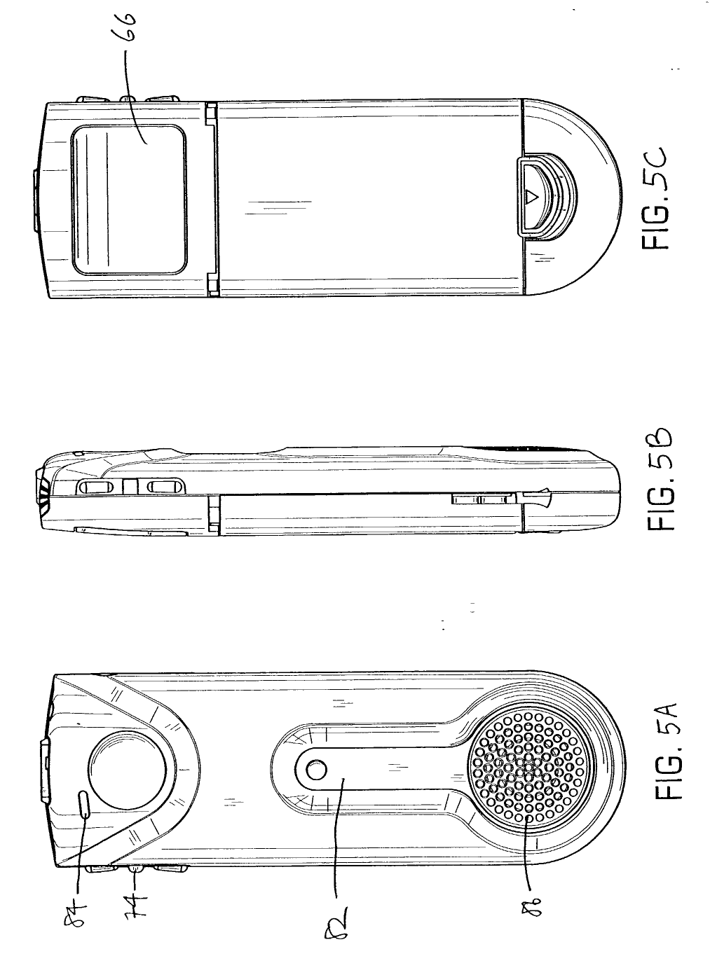

FIG. 3 is a block diagram of an exemplary central computer 36 in accordance with the invention. The central computer 36 is responsible for the overall control of the system. The server consists of a set of Java and C++ application programs 120 running on an Windows-based operating system 122 on Windows NT or Windows 2000 platforms, together with special-purpose hardware needed for telephony integration. In more detail, the central computer 36 may include a central processing unit (CPU) 124 and a memory 126 that stores software currently being executed by the CPU such as the operating system 122 and the JAVA and C++ applications 120 that implement the wireless communication functions of the wireless communications system. The server further comprises a persistent storage device 128, such as a hard disk drive, an optical drive, a flash memory or the like and a database 130 that stores information associated with the wireless communications system. The database stores user information, including the assignment of users to devices, speech files containing user name prompts and voice signatures, user preferences and buddy lists. It also keeps track of the whereabouts of users as they roam within the communications network. In large corporate installations, this component may interface to global employee databases maintained by the customer.

Some information fields in database 130 may include but are not limited to the following: user name, login name, password, alternative name/identifier, phone number and address, voicemail greeting message, ring tone, caller identifier status (on/off), buddy list, block list of calls to block, message forwarding service status (on/off and if on, to what number), distribution groups (e.g., “Memory Marketing team”), saved messages, and device serial number.

The central computer 36 may further include a computer network interface 132, such as the Ethernet Interface shown, that permits the central computer to be connected to the computer network and a telephone network interface 134 that permits the central computer to be integrated with a typical telephone system that may include, for example, a public exchange telephone system and a voicemail system. The central computer typically resides in the same location as the customer's telephone equipment so that it can interface to the PBX and the voicemail system.

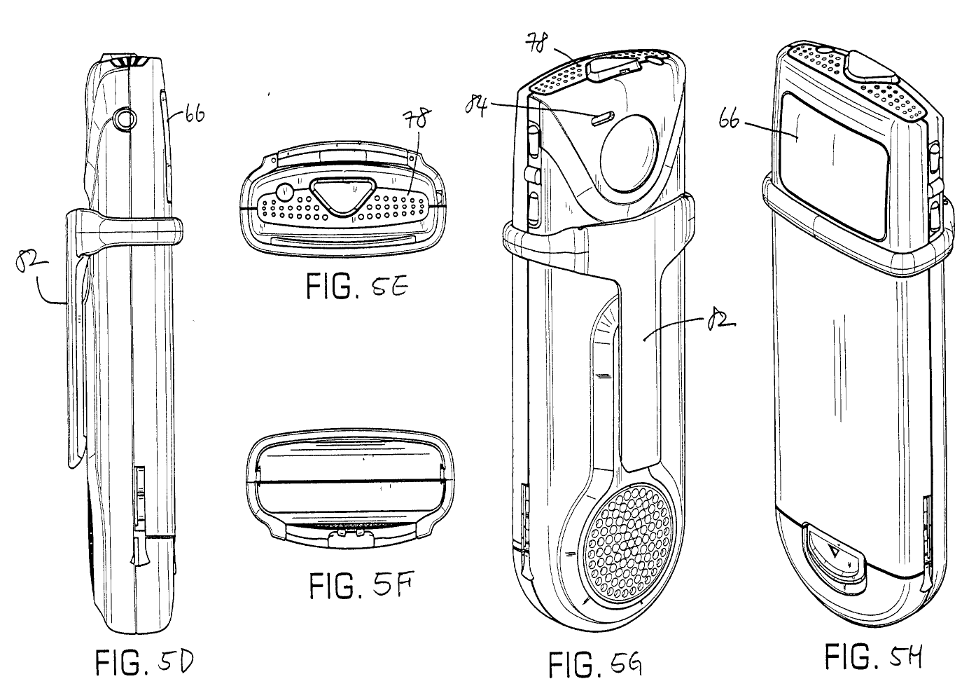

FIG. 4 illustrates more details of the central computer 36 shown in FIG. 3. In particular, the functional blocks of the software 120 are shown in more detail. The software may include a voice command interpreter 140, a call manager 142, a connection manager 144 and an administrator 146. The voice command interpreter 140 may be a component that includes a speech engine, such as the commercially available Nuance speech engine, is built onto the speech engine and has responsibility for interpreting and executing voice-based commands from both devices and externally initiated calls coming in from the public switched telephone network (PSTN). The call manager 142 has responsibility for the set-up and the breakdown of two-party and multi-party calls and maintaining status information associated with these calls and it connected to the PSTN or PBX. The connection manager 144 is the component that is responsible for managing access points and the connections between devices and access points so it is connected to the access points. It is also supports hands-off from one access point to another as a device roams about the network. The administrator module 146 supports administrator-level and user-level configuration and monitoring of the system through a web browser interface as shown. The telephony integration component may include hardware and software needed for the system to interoperate with the phone network. The hardware typically consists of one or more Dialogic or similar cards installed within the server machine, which might interface to a T1 trunk at the company PBX. The software will support an IVR interface that permits calls originating from the outside to be routed to the appropriate user.

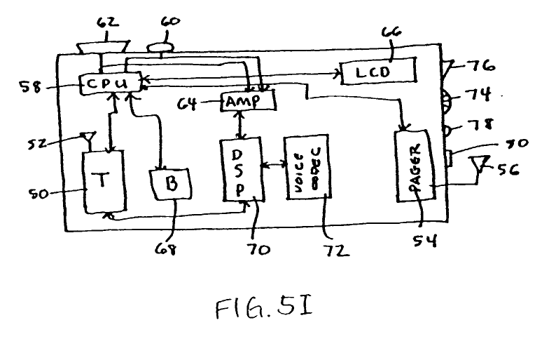

FIGS. 5A-5H illustrate a preferred embodiment of the communications device 32 in accordance with the invention and FIG. 5G is a block diagram illustrating the hardware components of the communications device in accordance with the invention. Before describing the details of the device, a general overview of the preferred device and its operation will be provided. Each device is a portable, battery-powered, lightweight, wireless device that serves as the primary communications endpoints of the system. The devices support hands-free, near full duplex voice communications using a small microphone (situated near the top of the device as described below) and a speaker (located near the bottom of the device as described below). In addition to the wireless communications, each device is preferably capable of receiving text pages (using a pager receiver as described below) and may include a display unit (as described below) to, among other things, permit reading of the text pages.

Each device is only capable of voice communications when it is within the network neighborhood of any access point. The typical range of a wireless access point is approximately 35 meters for an indoor access point and approximately 100 meters for an outdoor access point. Thus, when the device is not within the range of any access point, voice commands do not work. However, the device may still be used as a one-way text pager anywhere within the coverage area of a global pager service network.

The devices are sufficiently small and lightweight enough so that the device may be clipped onto a shirt pocket of the user, may be worn on a lanyard around the neck of a user or carried is a holster similar to cellular phone. In a typical environment with typical noise levels, hands-free operation using voice commands requires the device to be situated approximately 0.5 meters from the mouth of the user so that the voice commands may be understood by the central computer. Thus, if the device is carried in a holster, it may need to be removed from the holster and brought closer to the user's mouth for voice command, hands-free operation. For a semi-private conversation or operation in a loud environment with high noise levels, the device may be inverted (so that the speaker is near the user's ear and the microphone is near the user's mouth) similar to a typical telephone. Optionally, a headphone jack may be provided on the device. The device may also include a clip (as described below) that may be used to clip the device onto a shirt or shirt pocket or may be used to hold a corporate security device.

Returning to FIGS. 5A-5H, the embodiment shown includes the display device 66, a clip 82, a microphone opening 84 and a speaker opening 86. The display device 66 may be a liquid crystal display (LCD) that may be used for various purposes, such as reviewing text messages and pagers received by the pager receiver, to permit the user to control the operation of the device and its configuration using a control menu or to announce the origin of an incoming call. Each embodiment also includes an input device 74, an on/off switch, and a status indicator 78. The input device 74 permits the user to control the operation of the device and its configuration. In a preferred embodiment, the status indicator may include an LED that is capable of displaying one or more different colors to signal the operational status of the device. The device may further optionally include a headset jack that enables the user to plug in an external microphone/speaker headset, such as an ear bud. When the external headset is plugged into the headset jack, the operation of the internal microphone and speaker is inhibited. The devices may be powered by a renewable energy source, such as a replaceable, rechargeable lithium polymer battery, that attaches to the back of the device. A person of ordinary skill in the art would understand that the type and location of the various components on the device may be varied without departing from the scope of the invention.

FIG. 51 shows a block diagram of the device 32. Each device may include a wireless transceiver 50 and a antennae 52 (that may be a 100 mw Bluetooth radio transceiver, an appropriate strength IEEE 802.11 transceiver or any other wireless transceiver) that is used for wireless communications with the access points 34 or with other devices. Each device may further include a pager receiver 54 and an internal antennae 56 (such as a Motorola FLEX pager receiver and antennae) that operates to receive text messages/pages within the coverage of any global paging service network. The antennae for the wireless transceiver, in a preferred embodiment, may be built into the clip of the device. Each device is assigned a unique wireless device address (so that it can be identified by each access point and the central computer) as well as a unique pager address, such as a FLEX pager CAP code.

Also, the device may include a renewable energy source 68, such as a removable, rechargeable batter as shown, that may include protection and charge management circuitry as is well known to prevent over-charging. The device may further comprise a digital signal processor (DSP) 70 and an audio code 72 for processing incoming speech from the microphone and for generating the voice signals generated by the speaker.

Each device may further include a central processing unit (CPU) 58 that controls the operation of the device and each of its components including the wireless transceiver 50 and the pager receiver 54 as shown. The CPU 58 may control the manner in which device 32 sends and receives messages by controlling transceiver 50 and pager receiver 54. For example, CPU 58 may be programmed to keep the receiver 54 “awake” for a predefined period of time after the transmitter sends off a message to the central computer 36. The CPU 58 may be programmed to wake up the transceiver 50 and the pager receiver 54 at any time and at a desired frequency as long as the pattern of waking up complies with set industry standards.

The CPU 58 may also control a microphone 60 and a speaker 62 that are components of the device and permit the user of the device to communicate with the central computer 36 using voice commands and receive voice responses from the central computer 36. The microphone and speaker may also be used for voice communications with other device users or third parties. The device may further include an amplifier 64 that amplifies the signals provided to/from the microphone and speaker. Further details on device 32 are provided in U.S. patent Ser. No. 09/947,235, which is incorporated herein.

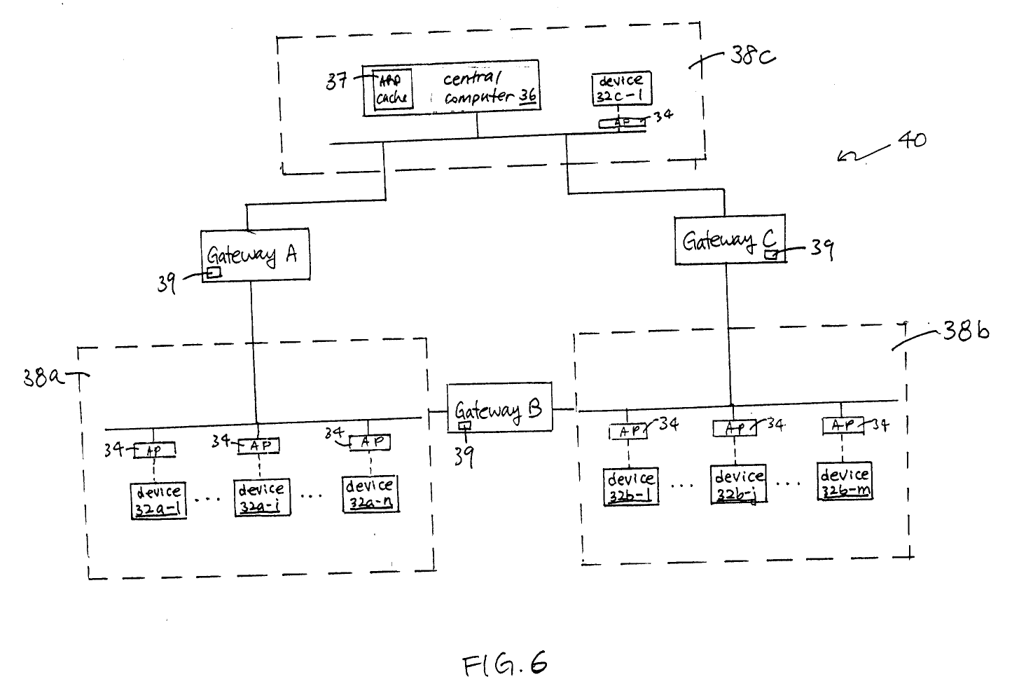

FIG. 6 depicts a network system 40 in which the invention may be implemented. The network system 40 includes a first LAN 38a with devices 32a connected thereto, a second LAN 38b with devices 32b connected thereto, and a third LAN 38c including a central computer 36. The first LAN 38a has devices 32a-1 through 32a-n wherein n is the number of devices in the first LAN 38a that are registered with central computer 36. A device 32a-i designates an arbitrary one of devices 32a-1 through 32a-n. The second LAN 38b includes devices 32b-1 through 32b-m wherein m is the number of devices in the second LAN 38b that are registered with central computer 36. The device 32b-j is an arbitrary one of devices 32b-1 through 32b-m. Each of first LAN 38a, second LAN 38b, and third LAN 38c includes access points 34 as in FIG. 1. Although not explicitly shown, each of LAN 38a, LAN 38b, and LAN 38c includes access points that may be associated with one or more devices 32. The third LAN 38c includes a device 32c-1 in addition to central computer 36. The device 32c-1 can communicate with central computer 36 directly through LAN 38c, unlike the devices that are part of LAN 38a and LAN 38b. The central computer 36 includes an ARP cache 37, which stores the physical addresses of all the devices that are part of the same LAN (i.e., LAN 38c).

The devices in the first LAN 38a, the second LAN 38b, and the third LAN 38c communicate with one another through a gateway. In the particular network 40 shown in FIG. 2, the first LAN 38a communicates with the third LAN 38c through Gateway A and with the second LAN 38b through Gateway B. The second LAN 38b and the third LAN 38c communicate with each other through Gateway C. A gateway is used to connect two LANs, as shown in FIG. 2. When a gateway connects two networks that use different protocols, the gateway may translate protocols so that the two LANs can communicate with each other despite the different protocols. However, this translational function of a gateway may not be necessary in some embodiments where the network system 40 is implemented with a single protocol, for example in an Ethernet network. A gateway may have multiple I/O ports and a computerized switch, which may be used to connect each I/O port to the LAN. Gateway A, Gateway B, and Gateway C also each has an ARP cache 39 where device addresses can be stored.

Four Modes of Operation

The device 32 of the preferred embodiment has four modes of operation: 1) power-off mode, 2) inquiry mode, 3) standby mode, and 4) active mode.

The power-off mode is the state in which the device is completely inactive. From the user's point of view, the device behaves very much as if the battery has been removed completely although the battery has not actually been physically switched off. The internal components of the device 32 are in their lowest-power state and the radio is disabled. Thus, reduction of power consumption is not necessary for a device in its power-off mode.

The inquiry mode refers to the state in which a device 32 is searching for the network. A device will transition to this mode, for example, if the user leaves the premises covered by an access point 34. In the inquiry mode, the radio is turned off almost completely most of the time, but is turned on briefly at a regular time interval (e.g., 30 seconds) to scan for access points. The inquiry sleep cycle differs from the Power Save Polling mode described above in that in the inquiry mode, no association is maintained with an access point during the inactive periods. As a device usually spends only a small fraction of the total operation time in the inquiry mode, implementing power saving methods for a device in the inquiry mode is not the most effective approach for decreasing the overall power consumption level.

The standby mode refers to the state in which a device 32 has found the network (e.g., LAN 38) but is not engaged in active communication. In the standby mode, the device is associated with an access point at all times. The device may change the access point with which it is associated as the device roams about the network (e.g., LAN 38). In a typical customer application, the device 32 will spend the great majority of its time in standby mode. Therefore, implementing power conservation methods for a device in standby mode is effective for decreasing the overall power consumption level of the device.

A device in standby mode is largely quiescent. However, periodically (e.g., every 30 seconds), the device “pings” central computer 36. “Pinging” is described in more detail below. While in the standby mode, the device may engage in the known 802.11 Power Save Polling scheme described above.

Finally, the active mode is the state in which the device is engaged in a communication session with one or more other devices or with the central computer 36. Since the device must be “awake” in order to communicate with other devices, PSP-type method of power conservation that puts the device in an “asleep” mode cannot be used in the active mode.

Pinging

A device in standby mode may send a User Datagram Protocol (UDP) message to the central computer 36 to announces itself and its location to central computer 36. The location may be defined by the currently-associated access point. This sending of a message by a device to the central computer to update information is herein referred to as “pinging.”

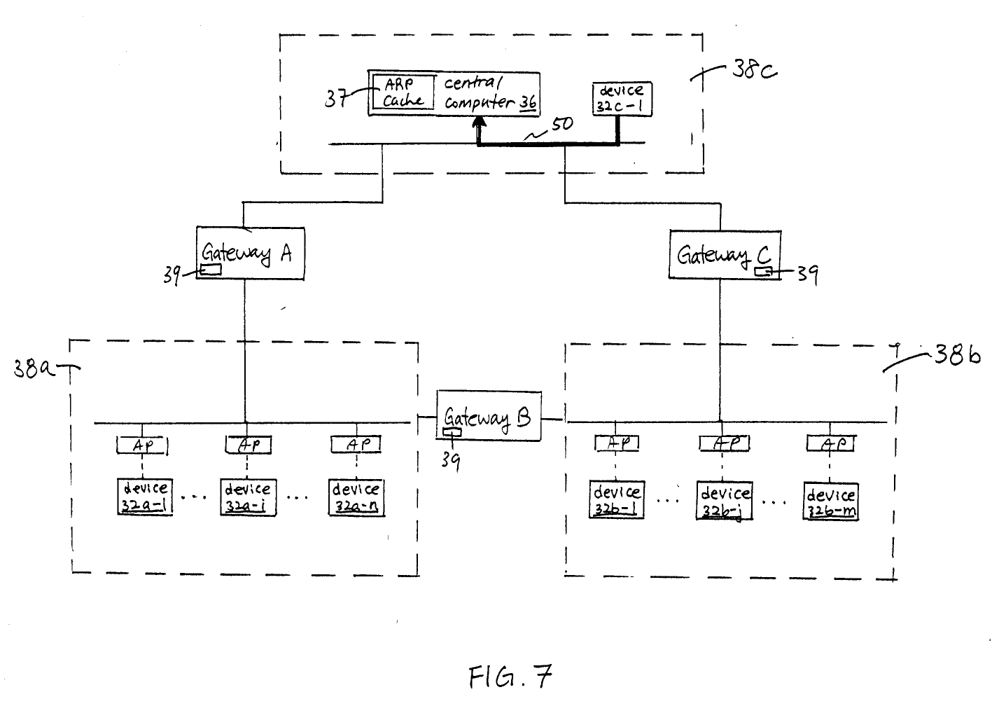

FIG. 7 depicts how a device that is part of the same LAN as central computer 36 pings central computer 36. More specifically, FIG. 3 depicts device 32c-1 pinging central computer 36 located in LAN 38c. A bold arrow 50 showing the direction of a ping packet indicates that the ping packet travels within LAN 38c and does not pass through a gateway.

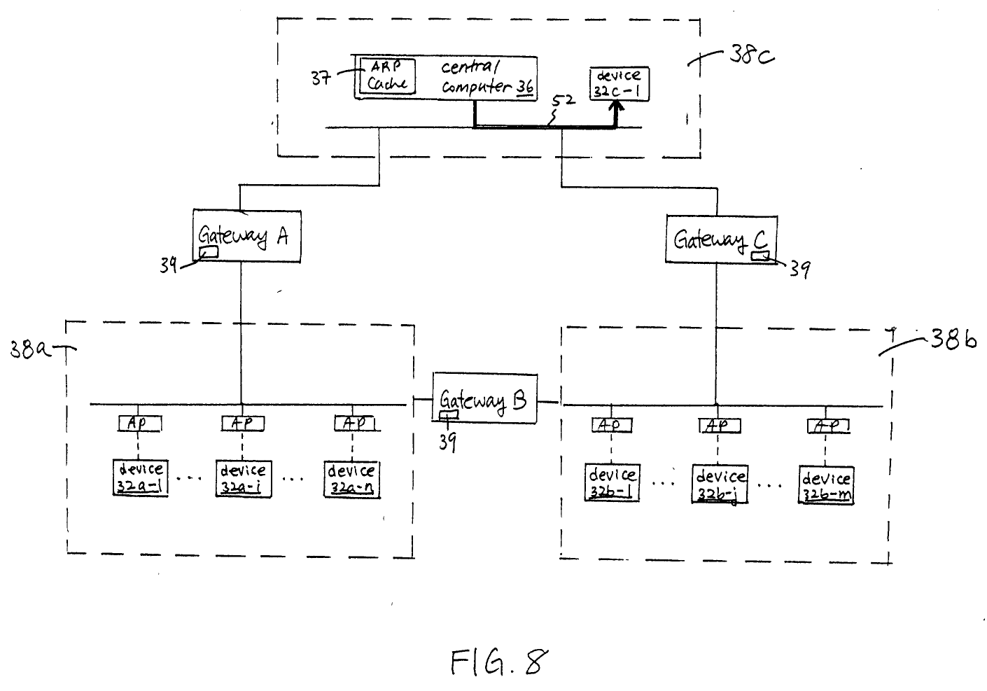

The central computer 36 receives the ping packet and sends a ping response packet back to the device that sent the ping packet, which in this case is device 32c-1. FIG. 8 depicts the path of this ping response packet in a bold arrow 52. The ping response packet travels the same path as the ping packet in the reverse direction. The central computer 36 knows where to send the ping response packet because the ARP cache 37 is always kept up-to-date by the ping packets and each of the ping packets contain the identity of the device from which the packet originated. Thus, when pinging occurs within the same LAN (in this case, LAN 38c), central computer 36 can easily figure out the physical address to which a ping response is to be directed.

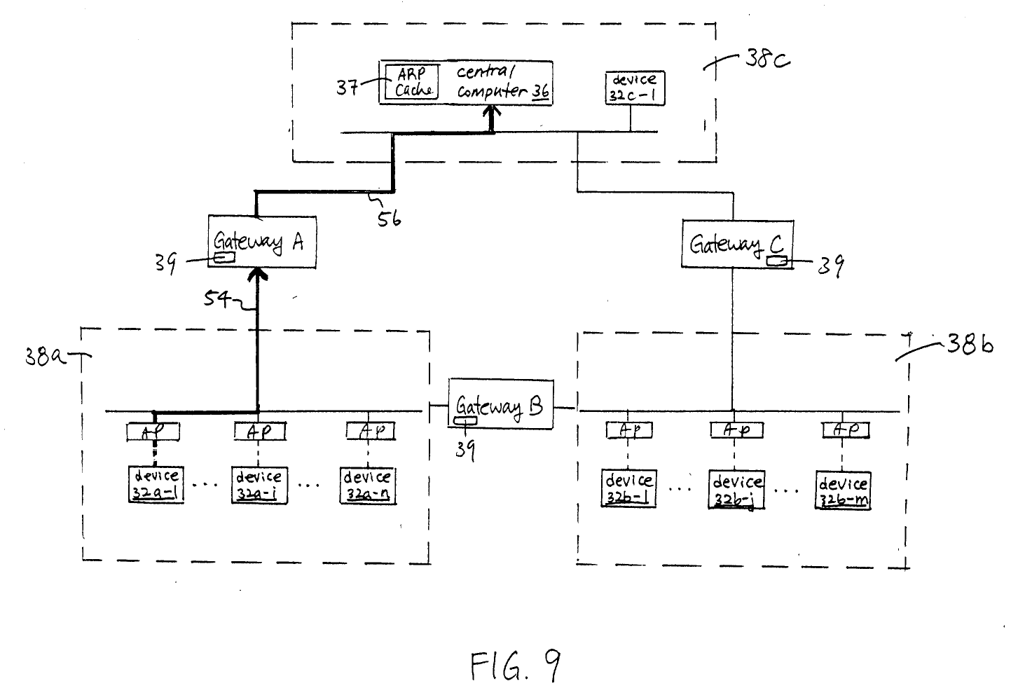

FIG. 9 depicts the path of a ping packet from device 32a-1 to central computer 36 with a bold arrow 54 and a bold arrow 56. When a device outside of the central computer's LAN (LAN 38c) pings central computer 36, the ping packet passes through a gateway. For example, a ping packet that originated in device 32a-1 can reach central computer 36 by either passing through Gateway A or by passing through Gateway B and Gateway C. The bold arrows 54 and 56 indicate that the ping packet in FIG. 5 reached central computer 36 through Gateway A. When a ping packet passes through a gateway, the gateway caches the physical address of the device from which the ping packet originated and stores the physical address in ARP cache 39. Thus, in the case of FIG. 5, Gateway A caches the physical address of device 32a-1 when the ping packet passes through Gateway A on its way to central computer 36.

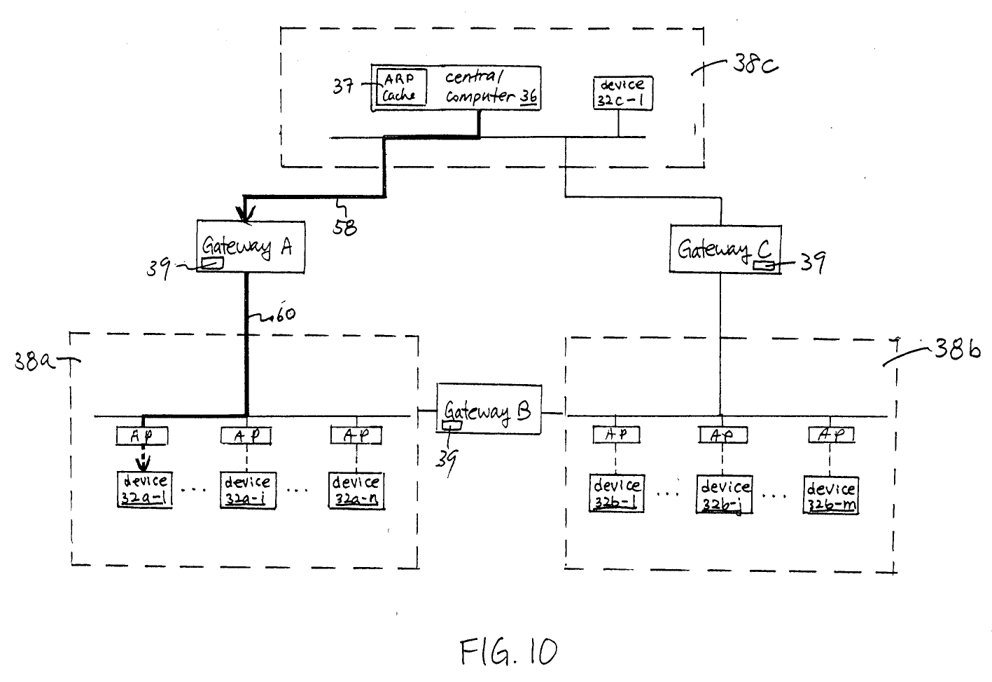

FIG. 10 depicts the first possible path of a ping response from central computer 36 to device 32a-1 in response to the ping packet shown in FIG. 5. Bold arrows 58 and 60 depict the path of the ping response packet. In this case, the ping response travels the same path as the ping packet but in the reverse direction. A person of ordinary skill in the art would understand that the central computer 36 knows to transmit the ping response to Gateway A based on the IP address of the sender device. Once the ping response packet reaches Gateway A, the physical address that was stored in Gateway A's ARP cache 39 is used to direct the ping response to device 32a-1.

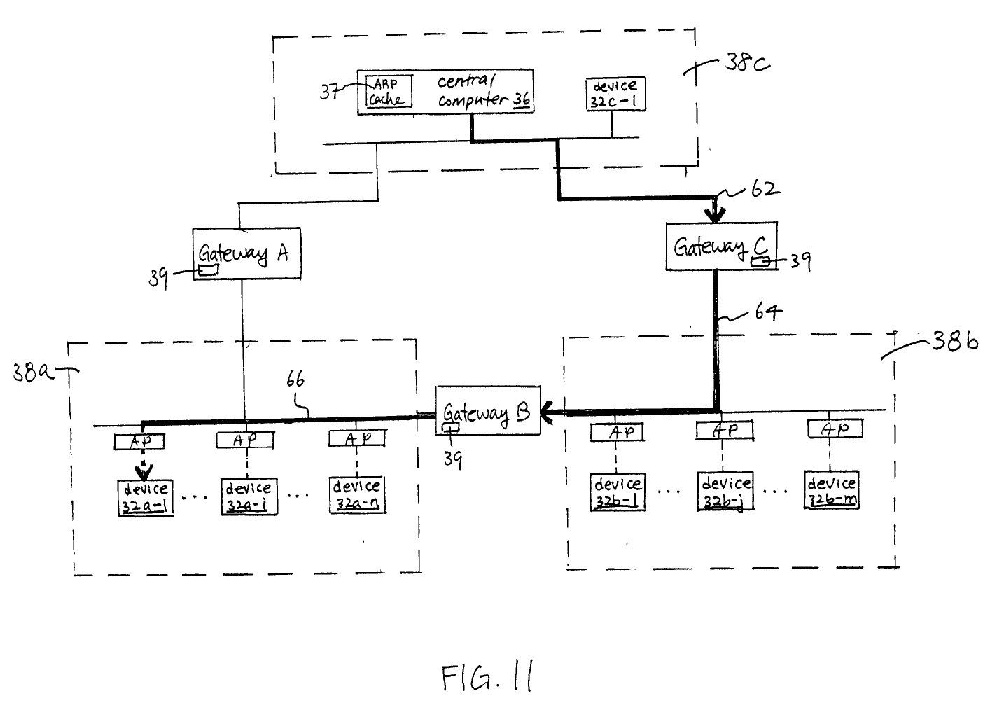

FIG. 11 depicts the second possible path of a ping response packet sent from central computer 36 to device 32a-1 in response to the ping packet shown in FIG. 5. The path of the ping response packet, shown by bold arrows 62, 64, and 66, is not the same as the path of the ping packet (bold arrows 54 and 56 of FIG. 5). The central computer first sends the ping response packet to Gateway C based on the IP address of device 32a-1. Similarly, Gateway C forwards the ping response packet to Gateway B based on the IP address of device 32a-1. Once Gateway B receives the ping response packet, however, Gateway B does not have a physical address for device 32a-1 because the ping packet never passed through Gateway B. The physical address Gateway B needs is stored in Gateway A because the ping packet passed through Gateway A on its way to the central computer 36. Thus, Gateway B needs to broadcast an ARP request to all the devices 32a of the first LAN 38a in order to determine the physical address of device 32a-1. In accordance with the standard broadcast protocol, Gateway B sends a packet to every device 32a that is a part of LAN 38a. Since each packet contains information allowing the recipient to recognize whether the packet is intended for the recipient, the correct device (device 32a-1 in this case) will know that the ping response packet is for itself.

When ping response packets are sent without a broadcast, as in FIG. 8 and FIG. 10, a device that sends a ping packet can predict with reasonable accuracy when it will be receiving a ping response packet. Thus, the device can prepare to be “awake” at the time the ping response packet is expected to arrive. Since device 32a-1, which is in the PSP mode, is in a “sleep” mode during its listening interval, the device may not receive the broadcast message or the ping response packet if the ping response packet does not arrive at the exact moment when device 32a-1 is awake. Due to this bad timing between the device's listening interval and the broadcast interval, there may be a time lag between when central computer 36 sends out the ping response packet and when device 32a-1 receives the packet. As a result, using PSP mode for the device may result in undesirably high latency. The PSP mode is often deliberately not used to overcome this latency problem, but then the power consumption level rises.

Power Conservation in Standby Mode

To lower the level of power consumption in standby mode, the broadcast/DTIM receiving function of device 32a-1 is disabled and a holdover mode is adopted in accordance with the invention. As a consequence of disabling the broadcast receiving function, device 32a-1 is unable to receive ARP requests while “sleeping” during the listening interval. However, the device 32a-1 will be able to respond to this request by being in a holdover mode. The holdover mode provides that for a predetermined period of time after device 32a-1 transmits a packet, the radio receiver of device 32a-1 remains awake, able to receive any type of signals including broadcast signals. The length of this predetermined time period is herein referred to as the “holdover period.” By setting the holdover period to a relatively large value (e.g., one second), device 32a-1 is able to respond to ARP requests for a period of time after the ping signal is transmitted. In order to further ensure that device 32a-1 receives all the signals that are intended for it, device 32a-1 may be configured to resend the ping packet before the entire holdover period elapses if no ping response packet has been received yet. This resending of the ping packet triggers another holdover period and keeps the receiver turned on until the ping response packet arrives. Preferably, the holdover period is no longer than a small fraction of the time interval at which ping packets are sent in order to minimize the effect of holdover on overall power consumption.

In addition to ping response packets, device 32a-1 must receive messages from the central computer 36 announcing incoming calls from other devices. Unlike for ping response packets that almost always arrive shortly after a ping packet is sent, the arrival times for incoming call messages are difficult to predict. However, the ping packets and the ping response packets keep the ARP cache 37 updated if the ping-originating device is on the same LAN as central computer 36 (as illustrated above in FIG. 3 and FIG. 4). If the ping-originating device is not on the same LAN as central computer 36, the ping packets update the ARP cache of a gateway it passes through on its way to the central computer 36. Thus, a call announcement packet is delivered to the proper device based on the stored physical addresses, although there may be a slight latency if the device is not “awake” when the call arrives. Once a call is set up, the device stays “awake” to send audio packets and is able to entertain ARP broadcasts.

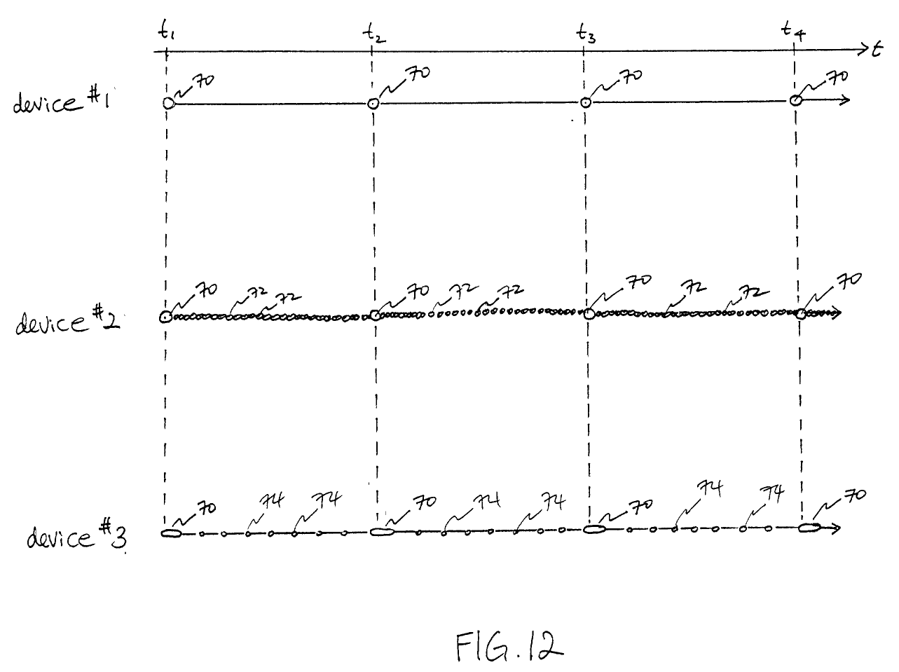

Disabling the broadcast receiving function and implementing the holdover mode results in power savings because a device in the holdover mode requires less power than a device configured with a broadcast receiving function. FIG. 12 compares devices having three different configurations: device #1 has no broadcast receiving function or holdover period, device #2 has a broadcast receiving function only, and device #3 has only a holdover period. In FIG. 12, a circular open area on a timeline indicates that the device is “awake” and a line indicates that the device is “asleep.” At times t₁, t₂, t₃, and t₄, each of the devices sends off a ping packet to the central computer. Since the devices have to be awake to send off the ping packets, there is a circular white area 70 at t₁, t₂, t₃, and t₄ for all three devices.

Aside from waking up to send off a ping packet, device #1 is asleep the rest of the time. While device #1 uses only a little power because it is only awake when it pings the central computer, it is not a practical implementation since it will not be able to receive any signals unless the arrival times of the signals coincide with the times when a ping packet is sent off. The amount of time device #1 spends in the “awake” state is close to the minimum amount of time a device in a communication network can spend in the “awake” state without potentially creating a confusion as to the location of the device.

As for device #2, which has a broadcast receiving function, it wakes up after every broadcast interval, which is typically short (e.g., 200 ms). If a ping packet is sent out every 30 seconds, device #2 has to wake up 150 times (5 times per second ×30 seconds) between t₁ and t₂, t₂ and t₃, etc. as depicted in FIG. 12 by small circles 72. There is almost no latency in device #2, which responds almost immediately to an incoming signal. However, the short latency comes at the price of a much higher power consumption level than device #1 since device #2 is awake for a much more greater proportion of total usage time than device #1. In contrast, a device in holdover mode stays awake for about one second after a ping packet is sent off, then stays “asleep” until the next ping. As a device spends most of its time in standby mode, power savings in standby mode results in significant overall power savings.

As for device #3, the holdover period configuration makes the device stay awake a little longer than is necessary to send off a ping packet at times t₁, t₂, t₃, and t₄. Thus, the open circle 70 that indicates sending off a ping packet is shown as a slightly elongated oval for device #3. Between pings, device #3 wakes up every listening interval, as shown by circles 74. Since the broadcast receiving function of device #3 is disenabled, device #3 does not wake up every, broadcast interval. Since a beacon interval is preferably a multiple of the broadcast interval and longer than the broadcast interval, device #3 does not wake up as frequently as device #2, which is why circles 74 are farther apart than circles 72. For example, when the broadcast interval is 100 ms, the listening interval may be set to be at least 500 ms long. In this case, device #3 would wake up every 500 ms to listen for a beacon (e.g., an incoming call), to send off a ping packet, and to receive broadcast signals instead of waking up every 100 ms to receive broadcast signals. Waking up less frequently results in lower power consumption by device #3 compared to device #2. There is, however, some latency associated with device #3 that is not present in device #2. Each time device #3 wakes up, there could be up to five beacon intervals' worth of beacon signals that are waiting to be received. A person of ordinary skill in the art would understand that a device's listening interval can be configured to be as long as it can be without the latency becoming intolerably long. For example, the listening interval may be set to be as long one second (1000 ms) in an application where reduction in the level of power consumption is more valuable than the response time of the device.

There may be a holdover period after each time a device sends a packet, and a ping packet is just one example of a packet the device sends. Although FIG. 12 shows the holdover period as being applied only when device #3 sends a ping packet, this invention is not so limited.

Since a device must wake up periodically to send a ping packet anyway to update the ARP caches, making the device stay “awake” a little longer after sending the ping packet results in little extra power consumption. Thus, the power consumption level of device #3 is not much higher than the power consumption level of device #1 but significantly lower than the power consumption level of device #2. Although device #3 is not awake for much more time than device #1, device #3 is drastically more likely to receive broadcast signals than device #1 because the little extra time that device #3 is awake is when broadcast signals are most likely to arrive. More specifically, device #3 is awake for about an extra one second after a ping packet is sent off and that extra one second is when an ARP request is most likely to be broadcasted, for the reasons explained above in reference to FIG. 11. Referring back to FIG. 11, the total time it takes for a ping packet to reach central computer 36 and the time it takes a ping response packet to reach Gateway B and broadcast an ARP request is typically less than one second.

In installations in which Dynamic Host Configuration Protocol (DHCP) is used, an alternative to the holdover mode may be used. According to this alternative method, each device pings all the gateway routers connected to its LAN periodically, thus keeping the ARP caches of the gateway routers updated. The gateway addresses are learned at the time the device performs DHCP to obtain an IP address.

The Effect of Holdover Period on Active Mode

A device in standby mode can become active in one of two ways. First, if the user presses the call button, the device transitions into the active mode in order to communicate with the central computer 36. Second, in the event that some other user has placed a call to the device, the central computer sends the device a UDP message causing it to transition into the active mode. Once in the active mode, the device communicates in a peer-to-peer fashion with the other parties to the call. When the call has finished, the device reverts to being in the standby mode.

Implementing the holdover period does not negatively affect the device's functioning in the active mode. The radio receiver of a device in the active mode stays turned on almost continuously to exchange audio packets rapidly with other parties. As a result, receiving an ARP broadcast request from central computer 36 or a call from other devices is not a problem when the device is in the active mode.

While the foregoing has been with reference to a particular embodiment of the invention, it will be appreciated by those skilled in the art that changes in this embodiment may be made without departing from the principles and spirit of the invention, the scope of which is defined by the appended Claims.

1. A method of reducing power consumption by a communication device having an awake mode in which the device can send and receive data through a communication network and an asleep mode in which the device cannot send or receive data, the method comprising:
sending a message to a central computer via the communication network, and
remaining in an awake mode for a predetermined holdover period after the sending.

2. The method of claim 1, wherein the device repeats the sending at a first regular time interval, further comprising waking up at a second regular time interval between two sendings to receive a signal from the server.

3. The method of claim 2, wherein the second regular time interval is a listening interval, wherein the listening interval is at least twice as long as a broadcast interval wherein the broadcast interval is the minimum time period between two broadcast signals.

4. The method of claim 2, wherein the device repeats the sending at the first regular time interval, further comprising postponing receipt of a broadcast signal until the device wakes up at the next second regular time interval.

5. The method of claim 1, wherein the message comprises information regarding a new location of the device.

6. The method of claim 1, wherein the device repeats the sending at a first regular time interval and the predetermined holdover period is less than or equal to 1/30 of the first regular time interval.

7. The method of claim 1, wherein the holdover period is about one second and the sending is repeated about every 30 seconds.

8. A method of reducing power consumption by a communication device, the method comprising periodically providing updated device location information to all cache memories in the network so that no Address Resolution Protocol-requesting broadcast is necessary.

9. A device for communicating wirelessly with a central computer, wherein the device has an awake mode in which the device can send and receive data through a communication network and an asleep mode in which the device cannot send or receive data, the device comprising:
a transmitter that sends a first message via the communication network;
a receiver that receives a second message from the communication network; and
a processor that controls the receiver and the transmitter, the processor including a code segment that makes the receiver stay awake for a predetermined holdover period after the transmitter sends the first message.

10. The device of claim 9, wherein the transmitter sends the first message at a regular time interval, further comprising a code segment that makes the receiver wake up periodically within the regular time interval.

11. The device of claim 10, wherein the receiver wakes up at an interval longer than a broadcast interval.

12. The device of claim 10, wherein the holdover period is less than or equal to 1/30 of the regular time interval.

13. A device for communicating wirelessly with a central computer through a communication network that includes Address Resolution Protocol caches, the device comprising:
a transmitter that sends a first message via the communication network;
a receiver that receives a second message from the communication network; and
a processor that controls the receiver and the transmitter, the processor including a code segment for updating the Address Resolution Protocol caches with the device's new location when the transmitter sends the first message.

14. A wireless communication system comprising:
a central computer; and
a remote device capable of communicating with the central computer via a communication network and having a processor, a receiver, and a transmitter, wherein the processor includes a code segment that enables the receiver to receive messages for a predetermined holdover period after the transmitter sends a message to the central computer.

15. A wireless communication system comprising:
a central computer having an Address Resolution Protocol cache; and
a remote device that communicates with the central computer through a gateway having an Address Resolution Protocol cache, wherein the remote device is configured to update the Address Resolution Protocol caches when transmitting a message to the central computer.
